(19) United States
(12) Patent Application Publication
(10) Pub. No.: US 2013/0203473 A1
(43) Pub. Date: Aug. 8, 2013

(54) Cellular Phone Case having a Keyboard Input

(71) Applicant: Amarnath Kota, Austin, TX (US)

(72) Inventor: Amarnath Kota, Austin, TX (US)

(21) Appl. No.: 13/755,162

(22) Filed: Jan. 31, 2013

Related U.S. Application Data
(60) Provisional application No. 61/595,912, filed on Feb. 7, 2012.

(51) Int. Cl. H04M 1/02

(52) U.S. Cl. CPC H04M 1/0202
USPC 455/575.8

(57) ABSTRACT

A protective case for a wireless communications device having a touch-screen interface is provided. The case has an upper lip joined to four sidewalls and a bottom to form an interior volume. The bottom extends downward and includes a storage cavity for releasably stowing a wireless keyboard. Wireless communication between the keyboard and the phone or tablet computer permits input of text and navigation commands to same. Users can detach the keyboard from the protective case and hold it in their hands without having to hold the communications device. After the user is done with the keyboard, it slides into the storage cavity. Releasable latches hold the keyboard within the cavity to prevent it from falling out when stowed. The case thus provides an easy to carry alternative input interface for users who dislike touch-screen interfaces.

### CROSS REFERENCE TO RELATED APPLICATION

This application claims the benefit of U.S. Provisional Application No. 61/595,512 filed on Feb. 7, 2012, entitled “Sliding Detachable Keyboard.” The patent application identified above is incorporated here by reference in its entirety to provide continuity of disclosure.

### BACKGROUND OF THE INVENTION

1. Field of the Invention

The present invention relates to a cell phone case with a detachable keyboard component. More specifically, it relates to a cell phone case having a wireless keyboard that is in operative communication with a cell phone stored in the case. The keyboard slides in and out of a cavity in the underside of the case for ease of storage. It will be appreciated by those who enjoy physical keyboards for texting and internet browsing on their phone, rather than touch-screen interfaces.

As technology trends move toward devices without peripheral input mechanisms, touch-screens become increasingly pervasive in the cell phone market. The majority of cell phones, smart phones, and small computing devices employ touch-screen interfaces. Instead of depressing numerals on a keypad to make phone calls, the user merely slides his or her finger along the screen. Instead of using pressure to activate individual key selections the way that keypads do, touch-screen interfaces generally rely on heat patterns emitted from a user's fingertips. This makes the interface difficult if not impossible to use with gloves on, or when the fingers are extremely cold. Similarly, the touch-screen itself has problems operating in extremes of temperature and can be easily damaged if left exposed in a hot or cold environment for too long. If the screen becomes damages by exposure to extreme temperatures, impact, water, or other trauma, the touch-screen interface will be wholly or partially unusable, leaving the user with no recourse except to have the phone fixed or replaced.

Despite their delicacy, touch-screen interfaces are used on all most all new cell phones, smart phones, and small computing devices. Phones utilizing keypads are limited to simple embodiments of cell phones that are realistically only useable for making phone calls and sending simple texts. It is not feasible to use these phones for browsing the internet, sending emails, watching videos, streaming music, or using complex phone applications. To take advantage of these features, consumers are steered towards smart phones and tablet computers, both devices that utilize primarily touch-screen interfaces. Not all users of smart phones and tablet pc's want to use touch-screen interfaces, but the alternatives are cumbersome notebook computer keyboards that are often larger than the phones themselves. An easily transportable wireless keyboard is needed that can communicate with a cell phone or tablet pc and can be easily stored near the device when not in use.

2. Description of the Prior Art

The present invention provides a cell phone case that removably houses a smart phone or small tablet pc. Along the underside of the case is a cavity with rails running along opposing sides of the cavity. A small wireless keyboard removably attaches to the rails so that may slide in and out of the cavity for storage. The keyboard connects with the cell phone or tablet pc via a wireless exam such as Bluetooth or other short range wireless communication protocol. A button on the side of the case can be depressed to disengage the keyboard from the tracks, thereby permitting a user to hold the keyboard while resting the phone on a surface. In one embodiment the keyboard has an internal battery, In another embodiment the keyboard has an electrical connection with the case and is charged by a battery disposed within the case. In yet another embodiment, the keyboard is electrically connected to the case, which is electrically connected to and draws power from the computing device. The prior art does not disclose a case for a cell phone or tablet computer case that removably retains a wireless keyboard.

Wireless keyboards that can be connected or wirelessly paired with a smart phone or tablet pc are used by those who occasionally need to input lengthy character strings into their device. The keyboards are usually full sized to allow adequate space for a user to type using all ten fingers. A wireless keyboard that folds in half for easy transportation is described in Wu, U.S. Patent Application Publication No. 2007/0049355. The Wu keyboard has a collapsible rack that is store within a backside of the keyboard when the device is not in use. The wireless communication device is placed within the rack and retained there while the keyboard is in use, so that the typist can easily view the communication device screen. Cell phones, personal digital assistants (PDAs), and similar devices can be wirelessly paired with the keyboard used at any location where the user has a flat surface to place the keyboard. Keyboards such as that described by Wu, are not practical for users on the go, because the keyboards cannot be used with just the thumbs, nor are they easily operable while held in a user's hands. Additionally, they do not come with a safe storage area attached to the phone. The present invention provides a cell phone case that has a cavity for removable storage of the keyboard to protect it from damage when it is not in use. The keyboard is sized for handheld use and does not require a support surface.

Other devices have attempted to address the problems solved by the current invention, by removably attaching a keyboard to the phone itself. Giancarlo, U.S. Patent Application Publication No. 2010/0302168 discloses several versions of a keyboard that snaps onto the surface of a cell phone. The keyboard comprises a plurality of depressible keys that tap the surface of a touch screen to make selections for a user. Downward force exerted by the user is transferred from the keys to the interface, resulting in individual alphanumeric selections. Thus the device provides a physical keyboard overlay for a touch screen interface. No wireless communication is necessary between the keyboard and the device because the interactions are mechanical in nature. Similarly, Kim, U.S. Patent Application Publication No. 2011/188176 teaches a physical keyboard that is physically mounted to a cell phone via straps or snaps. The keyboard rests over a portion of the touch-screen interface and may be electrically connected or wirelessly connected. In another embodiment, the keyboard is a full-sized folding keyboard similar to that of Wu. These devices are not incorporated into cases for storing the cell phone and keyboard. Nor are these devices slideably and removably secured to any protective phone housing. The present invention protects the cell phone or tablet device and the removable keyboard. Additionally, the keyboard of the present invention does not cover any of the touch-screen interfaces, leaving the entire screen visible to the user, unlike Kim and Giancarlo, which cover a portion of the cell phone screen when in use.

A soft cell phone or tablet computer case with a flexible keyboard is described by Dubrovsky, U.S. Patent Application Publication No. 2010/0238119. The case fits over the lower half of a touch-screen phone or tablet pc, and has a flexible keyboard hingedly attached at one end. The hinge permits the keyboard to rotate from a position parallel to and abutting the rear of the case, around to a position parallel to and overlaying the touch-screen interface of the phone. When the keyboard is positioned over the touch-screen interface a user can gently depress the keyboard key images to make selections on the touch screen. In a preferred embodiment the flexible keyboard is merely indicia printed on a flexible film, so that pressure and heat are transferred through the film to the touch-screen interface. The keyboard is not detachable, nor is it stored in a cavity within the case. The present invention has a keyboard that can be gripped and moved as needed and does not physically contact the touch screen interface of a cell phone or tablet computing device.

These prior art devices have several known drawbacks. They do not include a device case that protects both the underlying device and a keyboard input means. Nor do they disclose a hand-held wireless keyboard that can be used without holding the wireless device itself. The present invention provides a carrying case for a cell phone or tablet computer that contains a storage cavity for a removable keyboard. The removable keyboard is operatively connected to the underlying wireless device and can be used to input alphanumeric characters into the wireless device. It substantially diverges in design elements from the prior art and consequently it is clear that there is a need in the art for an improvement to the existing portable keyboards for wireless devices. In this regard the instant invention substantially fulfills these needs.

### SUMMARY OF THE INVENTION

In view of the foregoing disadvantages inherent in the known types of portable keyboards for wireless communication devices now present in the prior art, the present invention provides a new case with a storage cavity for a removably attached keyboard wherein the same can be utilized for providing convenience for the user when inputting alphanumeric characters into a cell phone or tablet computer without necessitating the use of a touch-screen interface.

The present invention is a protective covering for a cell phone or tablet computer. The case has four upstanding walls, an upper lip, a bottom surface, and an interior cavity for storing a keyboard. Rails disposed along opposing sides of the cavity interior permit a keyboard to slide in and out of the storage cavity. A button is included on one side of the case that can be engaged to release the keyboard from the rails. Users can detach the keyboard and hold it while the case and phone rests on a surface, in their lap, or the like. Alternatively, the user can leave the keyboard connected to the rails and slide it out to expose the keypad for use.

Several methods of communication between the keyboard and the cell phone or tablet computer may be employed. It is preferred that the keyboard is wirelessly in communication with the phone or tablet, so that the keyboard can be detached from its guiding rails. Butt, the present invention contemplates an embodiment including a universal serial bus (USB) connection between the keyboard and phone or tablet device. USB connections are ideal as an example of the type of connections that may be employed because they the USB connection places the two devices in communication and serves as a power exchange. Similar physical connections may be used. Some embodiments of the device may include a mixed connection capability such that the keyboard is physically connected to the phone or tablet via the case, when the keyboard is stowed, but it connects wirelessly to the phone or tablet upon detachment from the case.

It is therefore an object of the present invention to provide a new and improved wireless communication device case having a wireless keyboard that has all of the advantages of the prior art and none of the disadvantages.

It is therefore an object of the present invention to provide a cell phone or tablet computer keyboard that can be held in a user's hands and operated with the thumbs.

Another object of the present invention is to provide a physical keyboard for use with smart phones, tablet computers and any other device having a touch-screen interface.

Yet another object of the present invention is to provide a cell phone or tablet computer case that protects both the wireless communication device and a physical keyboard that can be used with the wireless communication device.

Still another object of the present invention is to provide keyboard that can be used while physically connected to a cell phone case or while detached therefrom.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the case of the present invention as used for protecting a cell phone. The keyboard is attached to the case's interior rails and positioned outside of the storage cavity where it is ready for use.

FIG. 2 shows a perspective view of the case of the present invention as used for protecting a cell phone. The keyboard is detached from the interior rails and can be carried away from the case while in use.

FIG. 3 shows a system diagram of a preferred embodiment of the case and keyboard components.

FIG. 4A shows a cross-section of the case with a cell phone or tablet computer housed therein, and the keyboard removed from the case's interior storage cavity.

FIG. 4B shows a cross-section of an alternative embodiment of the case with a cell phone or tablet computer housed therein and the keyboard removed.

FIG. 4C shows a cross-section of an alternative embodiment of the case with a cell phone or tablet computer housed therein, and the keyboard removed. This embodiment has a physical connection port disposed on a wall of the interior cavity for communicating with the keyboard or charging same, while it is stowed.

FIG. 4D shows a cross-section view of an alternative embodiment of the protective case. The keyboard is attached to a flap that is hingedly secured to a sidewall of the protective case.

FIG. 5 shows a cross-section of the portable keyboard while removed from the protective case.

FIG. 6 shows an overhead view of the portable keyboard while removed from the protective case. This embodiment of the keyboard has a physical connection that mates with a corresponding port in the case interior storage cavity when the keyboard is stowed.

### DETAILED DESCRIPTION OF THE INVENTION

Reference is made herein to the attached. Like reference numerals are used throughout the drawings to depict like or similar elements of the protective case with portable keyboard. For the purposes of presenting a brief and clear description of the present invention, the preferred embodiment will be discussed as used for protecting cell phones or tablet computer while providing a portable keyboard that can be used with the aforementioned device. The figures are intended for representative purposes only and should not be considered to be limiting in any respect.

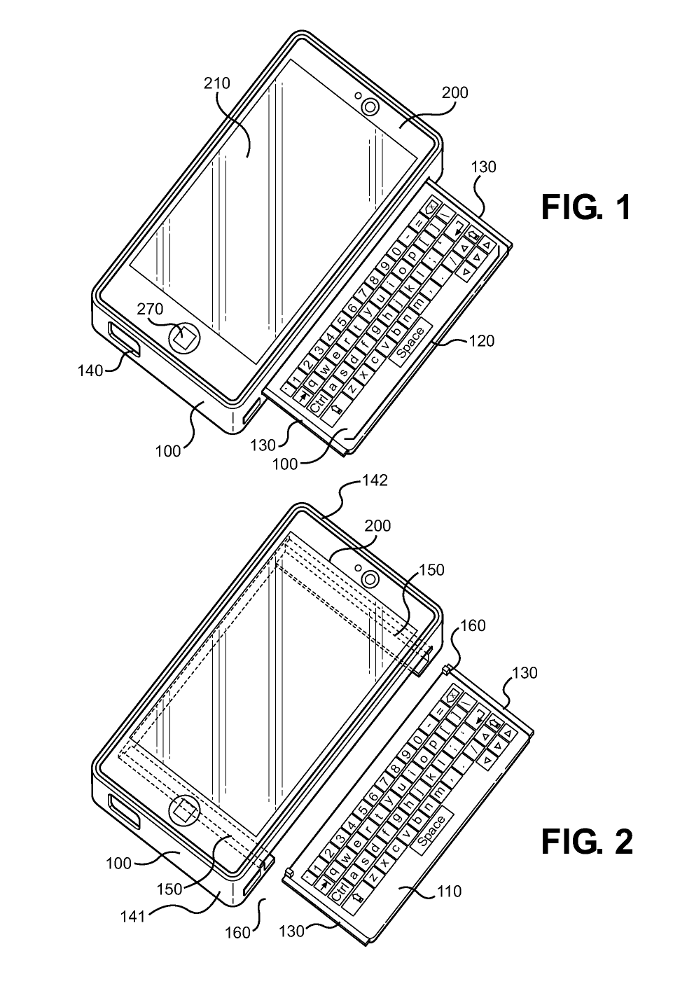

Referring now to FIG. 1, there is shown a perspective view of a smart phone device 200 encased in the protective case 100. The touch-screen interface 210 and buttons 220 are freely accessible while the smart phone is housed within the protective case. Device ports for power and data transfer connections are accessible through apertures 140 in the sides of the case. A keyboard 110 extends from a storage cavity disposed in a lower portion of the case. Thin rails 130 are disposed on laterally opposing sides of the keyboard for slideably engaging with channels in the interior cavity of the protective case. The keyboard remains attached to the sliding rails until the user activates a release button that disengages the keyboard from the protective case. When the keyboard is slid out of the cavity into an extended position and remains attached to the protective case, the input keys 120 are exposed. This extended position permits use of the input keys without detaching the keyboard, making it easy to slide the keyboard back into the cavity when typing is completed. In this manner, the present invention provides a portable keyboard that can be used while it is still attached to the protective case or when fully detached.

In another embodiment, the keyboard is not detachable. The keyboard is connected to the wireless communications device through the protective case itself. The keyboard can be slid in and out of the storage cavity, but cannot be disengaged once in the extended position. Thus, the keyboard remains in electrical and operable connection with the protective case at all times. This embodiment presents advantages in the form of increased battery life and reduced risk of losing the keyboard.

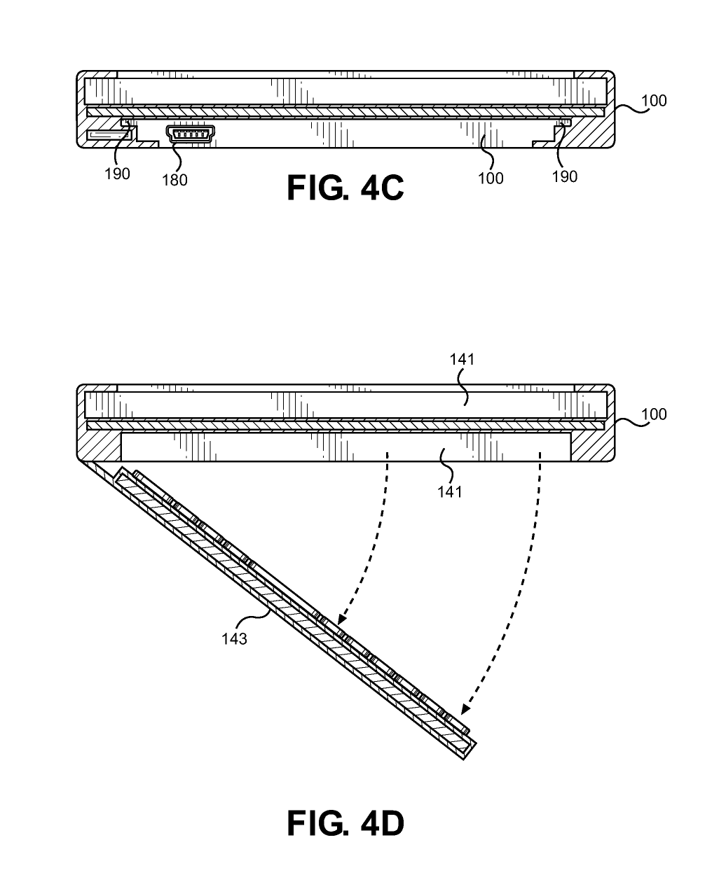

Referring now to FIG. 2, there is shown a perspective view of a smart phone housed in the protective case. The protective case 100 houses a smart phone 200 but does not cover any portion of the upper surfaces except a small perimeter area. This perimeter portion of the phone upper surface is covered by an upper lip 142 of the protective case. The upper lip extends from upper edges of the four case sidewalls 141 and forms a perimeter boundary. In an exemplary embodiment the upper lip extends laterally inward from the upper sidewall edges, but the angle of incidence may be adjusted to accommodate different styles and sizes of devices. Lower edges of the sidewalls are connected to the bottom wall of the case, which extends downward forming a bottom or rear portion. It is preferred that the bottom wall is a solid planar wall that segregates the upper cavity from the bottom portion. A cavity extends through this bottom portion, as shown in FIGS. 4A-4C. Cavity channels 150 disposed on laterally opposing sides of the interior storage cavity are viewable through the smart phone device in FIG. 2. These channels engage with the rails 130 of the portable keyboard 110 to permit insertion and removal of the same into the storage cavity. Small tabs 160 on the keyboard engage with recesses n the channel to lockably secure the keyboard in a fully stored or extended position. The keyboard can be released from the locked positions via interaction with a release button 170 disposed on the side of the case. Here, the keyboard is shown in a disengaged state, free from attachment to the protective case. The keyboard remains in wireless communication with the smart phone device so that the input keys 120 continue to operate.

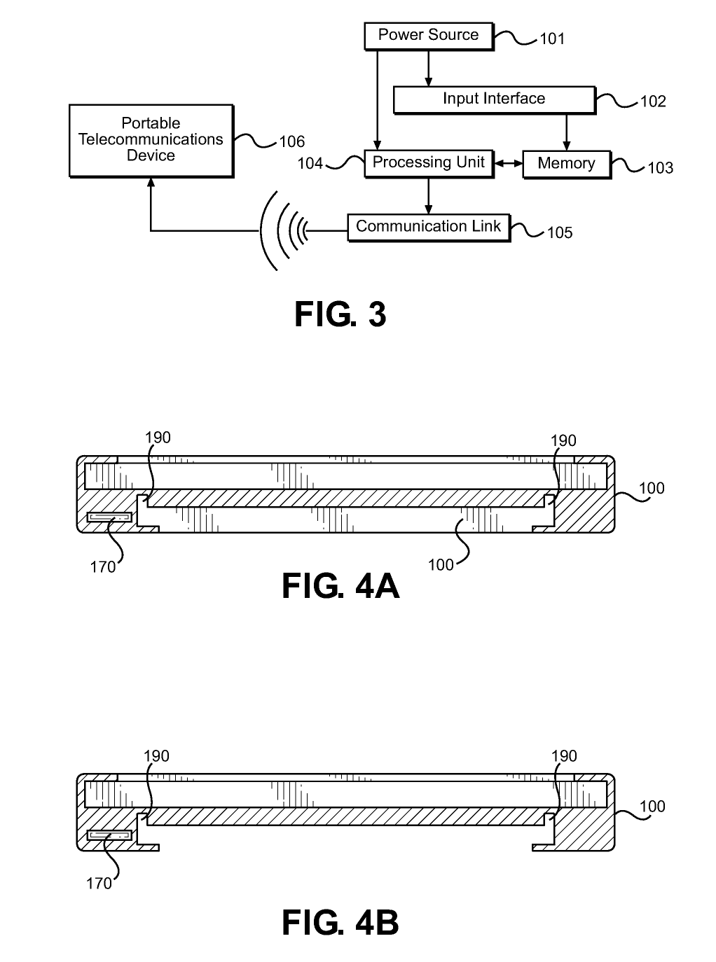

The system schematic of FIG. 3 illustrates the exemplary operation of the protective case. Inside the keyboard, a processing unit and main memory 103 are electrically connected to receive input from an input interface 102. Input keys on the keyboard upper surface are the input interface of the preferred embodiment. User input to the keyboard is transmitted in the form of electrical signals to the processing unit for translation and then loaded into memory for use by the communication link 105. A small wireless transceiver is responsible for receiving device pairing initialization information, and sending keyboard input to the portable communications device 106. It is preferred that a short range, strong signal, wireless protocol such as Bluetooth. The Bluetooth protocol has an active transmission range of approximately 30 feet and is therefore ideal for use between devices that may not be in constant contact, but will not travel far from each other. In the se of the present invention, the keyboard may be used while it is not connected to the smart phone or tablet computer, but it is unlikely that the user will roam far from the portable device, because visual confirmation of the device screen is needed to ensure correct input from the keyboard.

Internal components are powered by a small onboard battery source 101. Alternatively, the power source may be a USB connection between the keyboard and the portable communications device. In this embodiment, a power transfer connection runs through the case such that a connection port is disposed within the internal cavity, and is connected to a port disposed along the interior of one of the four sidewalls. Thus, the smart phone plugs into the sidewall connection and the keyboard plugs into the interior cavity connection, creating a power transfer link between the device and the keyboard, while the keyboard is in a stowed state. Keyboards are known in the art of computer systems input interfaces, and the knowledge needed to address necessitated variations on the aforementioned structure and design will be obvious to one of ordinary skill in the art.

In the embodiment of the device where the keyboard is permanently connected to the case, the battery, processing unit, memory, and communication link are located within the protective case. These components are electrically connected to the keyboard input interface via wiring between the keyboard and the case. The protective case battery may be sufficient to power the keyboard, or the case may be plugged into a port on the wireless communications device that facilitates power transfer to the case. In this way, the communications device provides power to the case and keyboard. Further, plugging the device into a USB or mini-USB port disposed within the case sidewalls will permit the keyboard to be used in a wired transfer mode, eliminating the need for a wireless connection. Therefore, the keyboard can be used with a wired or wireless communication link, depending on whether the underlying device is plugged into the protective case.

A cross-section view of the preferred embodiment of the protective case is shown in FIG. 4A. The upper lip of the protective case extends outward from the sidewalls and forms an upper boundary of the upper cavity. Sidewalls of the case protect a portable communication device placed within the upper cavity. As seen in the figure, the bottom portion of the case extends below a housed device and contains an interior storage cavity. This interior storage cavity has three walls, one of which is a longitudinal sidewall of the protective case. Two shorter walls formed from the bottom portion itself, extend between the longitudinal cavity wall to an opening in the opposing longitudinal sidewall. Channels, sized to accommodate the keyboard rails, are disposed along the shorter cavity walls. When the keyboard is housed within the case, the bottom surface of the keyboard is relatively flush with the bottom surface of the protective case

One or more grooves, or small notches 190 extend from each channel. These grooves accept the keyboard tab to prevent the keyboard from detaching from the case, when not in use. By way of example, A groove may be disposed at opposing ends of each channel. When the keyboard is fully inserted into the storage cavity, depressible tabs on the keyboard will decompress and extend into the groove. The tab will fill the majority of the volume within the groove, thus preventing the keyboard from sliding forward along the channels and rails. Similarly, when the keyboard slides forward into the extended position, the tabs will decompress and engage with grooves disposed at that end of the channels, preventing the keyboard rails from disengaging from the channels. The input keys of the keyboard can be used while the keyboard is in this extended, engaged position. A release button 170 is provided that is operatively connected to a ram located at one end of the grooves. When the release button is depressed, slid, or otherwise activated, the ram exerts force on the depressible tabs of the keyboard, effectively ejecting them from the grooves. The keyboard is then free to slide along the channels until the tabs encounter another groove or until the keyboard disengages from the case. It should be understood that the method of removably securing the keyboard to the case described herein is for exemplary purposes only. Latches commonly known in the art may be used to prevent the keyboard from inadvertent disengaging. Pressure exerting brakes are another contemplated means of preventing the keyboard from sliding out of the storage cavity. The release button is activated to retract the brakes and permit the keyboard to slide freely along the cavity channels. Additionally, the precise positioning and placement of the brakes or latches will be known to one or ordinary skill and all potential variations need not be addressed herein.

An alternative embodiment of the protective case is shown in FIG. 4B. In this embodiment, both longitudinal sidewalls of the protective case 100 are open to permit the keyboard to slide out from either longitudinal side of the case. The Keyboard can slide along the channels until it extends from either opposing side of the case. This permits users to position the keyboard in the manner most comfortable for their personal use. It may be preferable in this embodiment that the keyboard has tabs located on each corner, and corresponding grooves 190 in each corner of the storage cavity, to prevent the keyboard from unintentional disengagement from either opening.

Still another embodiment of the protective case is shown in FIG. 4C. This embodiment is similar to that depicted in FIG. 4A but contains the added element of a USB port 180. It is disposed along the longitudinal sidewall of the interior cavity and mates with a corresponding USB port on a longitudinal side of the keyboard. The port is electrically connected through the case to a port disposed on the interior of a sidewall upper portion. The upper port engages with a USB port in a cell phone, tablet or other portable communications device to provide a power transfer connection between the communications device and the keyboard. Specific positioning of the upper port will vary according to the type of device used in the case. These variations will be produced during manufacturing of different styles of the protective case. Further, other power transfer connections may be used, such as mini-USB, AC/DC, and the like, may be substituted for the USB connection. This embodiment of the protective case reduces the size and capacity of onboard battery needed by the keyboard. It also presents the advantage of being rechargeable via any USB connection. Thus the keyboard can be recharged via a USB connection with a laptop or wall outlet. The orientation and position of the connection port is not limited to that shown in the figure. It is contemplated, that the port can be rotated 180 degrees, requiring the keyboard to be inserted with the input keys facing outward. This permits use of the input keys while the keyboard is plugged into the protective case by simply flipping the phone over and typing, then flipping it again to check the screen for correctness.

In FIG. 4D there is shown another alternative embodiment of the case. Here, the interior storage cavity has no channels and its sidewalls extend straight down on all four sides. A flap 143 is secured along one sidewall 141 of the case, so that it swings open and rests within the storage cavity when closed. The keyboard is secured to an interior surface of the flap and folds up into the storage cavity when not in use. Communication between the keyboard and wireless communications device may be via wireless connection such as Bluetooth or may alternatively be wired through the protective case of the non-detachable embodiment described above. The keyboard is protected within the case's interior storage cavity, just as in other embodiments of the present invention, but a hinged flap is used in lieu of rails and channels as a means for inserting and removing the keyboard from the cavity.

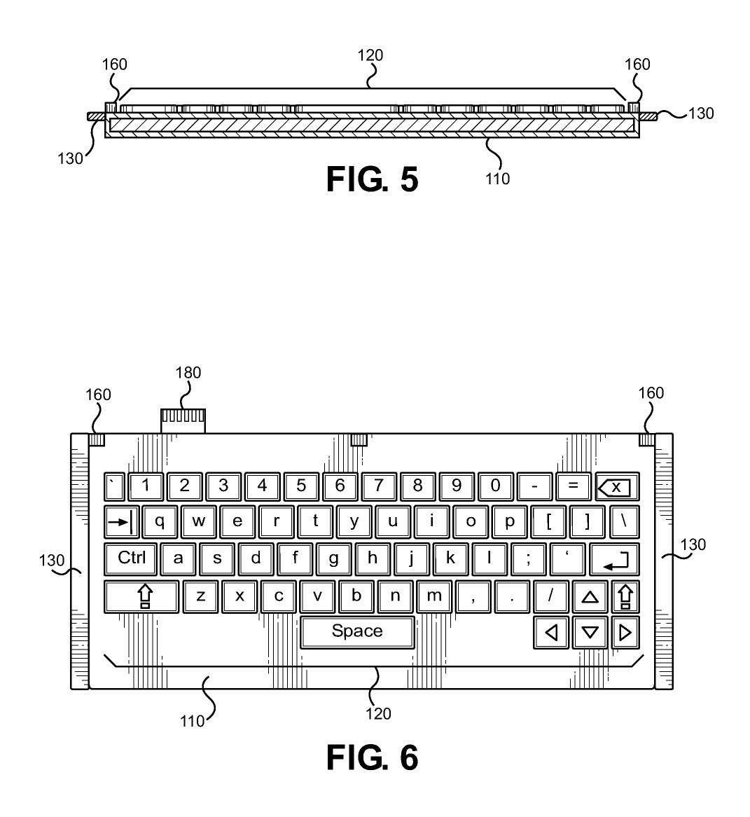

Turning to FIG. 5, a cross-section of the mobile keyboard is shown. The keyboard 110 has input keys 120 disposed along an upper surface. Tabs 160 are disposed in corners on the upper surface to engage with grooves in the interior storage cavity of the protective case. In a preferred embodiment, these tabs are depressible so that they can easily be disengaged when the keyboard is needed by a user. Side rails 130 extend laterally from opposing latitudinal sides of the keyboard. These rails slideably engage with channels in the interior storage cavity to hold the keyboard in a stowed state within the protective case. Between the upper surface and lower surface of the keyboard is a circuitry layer that contains the components shown in FIG. 3. The overall size and shape of the keyboard is light and adapted for handheld use. Further, the bottom of the keyboard should fit flushly with the bottom of the protective case when the keyboard is stowed.

An overhead view of the keyboard is shown in FIG. 6, which provides greater detail of the upper surface. In the figure, the input keys 120 are shown as a qwerty keyset, but this is not the only key configuration that can be used with the present invention. Key indicia and configuration may be altered to accommodate alphabets from different regions of the globe. The input keys may be constructed of soft conformable materials, or rigid plastics. Upper and lower surfaces of the keyboard may be coated in the same material as the protective case or may be covered in a different substance. In the depicted embodiment, the keyboard has a male USB port 180 that can electrically connect with a corresponding port on the protective case.

In use an individual places a smart phone or tablet computer in the protective case so that the screen of the device is oriented upward. The upper lip of the protective case should snuggly abut the device's upper surface perimeter. Both the touch screen interface and any device operations buttons should be freely accessible by the user. The user then depresses a release button on the side of the protective case to disengage the case's securing latches. Gentle rubbing motion is applied to the bottom of the keyboard to slide it out from the case interior storage cavity. Once the input keys are exposed the user can choose to leave the keyboard in an attached, extended position or detach it fully from the protective case. The individual exerts downward pressure on the keys to input selections into the operating system of the smart phone or tablet computer. Input keys may be used in lieu of the touch screen interface or in conjunction therewith, depending on the implementation of the device. After the user is done typing her message, she slides the keyboard back into the storage cavity in the protective case, until the keyboard is fully housed within the cavity. The device can be safely stowed in a purse, pocket, or other container until needed.

The invention as described is a protective case for a cell phone having four upstanding sidewalls that extend between a small perimeter boundary lip and a bottom portion. The bottom portion presents a floor to the portable communications device holder portion of the case and extends downward therefrom. An interior storage cavity in the case receives and releases a small keyboard that is in wireless communication with the communications device stored in the upper portion of the case. Users can disengage the keyboard from the case via a release button and hold the keyboard in their hands without holding the bulky weight of the smart phone or tablet computer. The keyboard may replace most or all input functions of the touch-screen interface, or alternatively may be used for simply inputting text and navigating around the wireless device graphical user interface. Input is accomplished via a wireless connection such as Bluetooth or other short range connection, preferably a radio frequency connection.

Material construction of the device may change according to manufacturing needs, and user preferences. Plastics, rubber, and other semi-rigid materials are ideal for use as a frame for the case and keyboard because they are shock absorbent and somewhat flexible thereby permitting easy insertion and removable of the device. In embodiments of the device where the case is made of hard plastic or other inflexible material, the case will be made in two parts that snap together. For example the upper lip and sidewalls may detach from the bottom portion then snapped together once a wireless communications device is inserted into place. Alternatively, the upper lip may detach from the sidewalls to allow a phone to be inserted in the upper cavity. The protective case is versatile in its potential construction configurations, which is desirous in the wireless communications device accessories market.

To this point, the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A protective wireless communications device case having a wireless keyboard, comprising:
a protective casing having four sidewalls, an upper lip, and a bottom portion, defining an interior volume, wherein said interior volume is adapted to removably retain a wireless communications device;
an interior storage cavity disposed within said bottom portion;
a wireless keyboard removably housed within said storage cavity.

2) The device of claim 1, wherein said storage cavity has a pair of channels disposed on laterally opposing sidewalls.

3) The device of claim 1, further comprising latches disposed on said keyboard.

4) The device of claim 3, wherein said latches are depressible tabs.

5) The device of claim 1, further comprising:
a release button operatively connected to a keyboard engagement means, and wherein activation of said release button permits said keyboard to slide in and out of said storage cavity.

6) The device of claim 1, wherein said keyboard has rails disposed on laterally opposing.

7) The device of claim 1, wherein said keyboard is a Bluetooth enabled keyboard.

8) The device of claim 1, wherein said storage cavity has a longitudinal opening, one longitudinal wall, and two latitudinal walls.

9) The device of claim 1, wherein said storage cavity has two latitudinal walls and two longitudinal openings.

10) The device of claim 1, further comprising a first physical connection port disposed within said storage cavity, and a second physical connection port disposed within said interior volume.

11) The device of claim 10, wherein said keyboard has a corresponding physical connection port disposed on a side that mateably engages with said first physical connection port.

12) The device of claim 10, wherein said second physical connection port is positioned to mateably engage with a corresponding physical connection port on a wireless communications device housed within said interior volume.

13) The device of claim 10, wherein said first and second physical connection ports are universal serial bus ports.

14) The device of claim 10, wherein said first and second physical ports are mini-universal serial bus ports.

15) The device of claim 1, further comprising:
a flap hingedly secured to an edge of said bottom portion and having an inner and outer surface;
said keyboard being attached to said inner surface, and positioned to align with and fit within said storage cavity when said flap is closed.

16) A protective wireless communications device case having a keyboard, comprising:
a protective casing having four sidewalls, an upper lip, and a bottom portion, defining an interior volume, wherein said interior volume is adapted to removably retain a wireless communications device;
an interior storage cavity disposed within said bottom portion;
a keyboard housed within said storage cavity, and secured therein by a slideable engagement means;
a connection port disposed along a sidewall interior and electrically connected to said keyboard via said protective case.

17) The device of claim 16, wherein said storage cavity has two latitudinal walls and two longitudinal openings.
